(19) United States
(12) Patent Application Publication
(10) Pub. No.: US 2008/0290574 A1
(43) Pub. Date: Nov. 27, 2008

(54) LOCATING BLOCK HOLDING DEVICE

(75) Inventor: WEN-QI LV, Foshan (CN)

Correspondence Address: PCE INDUSTRY, INC.;ATT. CHENG-JU CHIANG, 458 E. LAMBERT ROAD, FULLERTON, CA, 92835, US

(73) Assignees: PREMIER IMAGE TECHNOLOGY(CHINA) LTD., Foshan City (CN); HON HAI PRECISION INDUSTRY CO., LTD., Tu-Cheng (TW)

(21) Appl. No.: 11/946,277

(22) Filed: Nov. 28, 2007

(30) Foreign Application Priority Data
May 22, 2007 (CN) 200710200677.X

(51) Int. Cl. B25B 11/00

(52) U.S. Cl. 269/8

(57) ABSTRACT

A locating block holding device comprises a fixture floor, a magnet and a locating block. The fixture floor defines a channel and a coaxial receiving groove formed underneath the channel thereof, the receiving groove communicating with the channel with a shoulder formed between the receiving groove and the channel. The magnet is received in the receiving groove. The locating block, made from magnetic material such that the magnet is capable of firmly and stably holding the locating block on the shoulder in the channel, is disposed on the shoulder in the channel and above the magnet.

### TECHNICAL FIELD

The present invention relates to a positioning device and, particularly, to a locating block holding device which can be easily disassembled or replaced.

### BACKGROUND

A locating block servers as an auxiliary positioning tool to help position a workpiece on a worktable quickly, accurately, and conveniently, and also as a core of a die. Thus, the locating block is widely used in the art of products manufacturing. However, how to fix or hold the locating block on the worktable is very important for accurately positioning the workpiece. In practice, there are generally two methods available for fixing or holding the locating block on the worktable: one is using a bolt to connect both the locating block and the worktable together, and the other is using an adhesive to bond them together. However, in the former method at least one threaded hole must be drilled in the locating block and a corresponding threaded hole in the worktable, then a bolt is received in the threaded holes to join the block and the worktable together, which is inconvenient to disassemble, in addition, the manufacturing process is also complicated. The usable range of the latter method is limited because the adhesive can't bond well at high temperatures, and the strength of the adhesive is too low to withstand the sudden application of a load thereon.

Therefore, a locating block holding device having a simple structure and is convenient to disassemble or replace is desired.

### SUMMARY

In a present embodiment, a locating block holding device comprises a fixture floor, a magnet and a locating block. The fixture floor defines a channel and a coaxial receiving groove formed underneath the channel thereof, the receiving groove communicating with the channel with a shoulder formed between the receiving groove and the channel. The magnet is received in the receiving groove. The locating block, made from magnetic material such that the magnet is capable of firmly and stably holding the locating block on the shoulder in the channel, is disposed on the shoulder in the channel and above the magnet.

Those and other advantages and novel features will be more readily apparent from the following detailed description set forth below taken in conjunction with the accompanying drawings.

### BRIEF DESCRIPTION OF THE DRAWINGS

FIG. 1 is a schematic, cross-sectional view of a locating block holding device, according to a first preferred embodiment;

FIG. 2 is a schematic, cross-sectional view of a locating block holding device, according to a second preferred embodiment;

FIG. 3 is a schematic, cross-sectional view of a locating block holding device, according to a third preferred embodiment; and

FIG. 4 is a schematic, partial top plan view of FIG. 3.

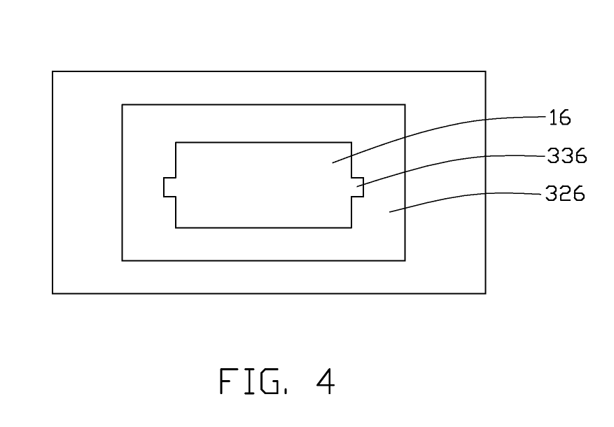

### DETAILED DESCRIPTION OF THE PREFERRED EMBODIMENTS

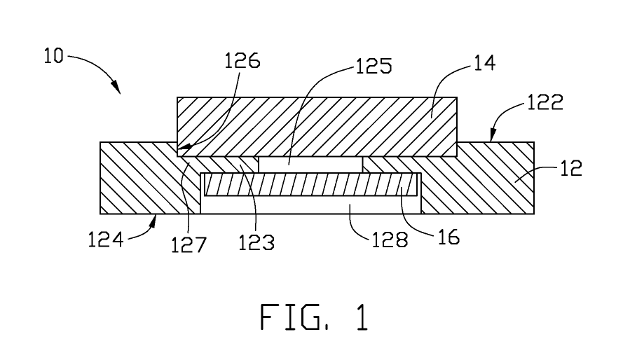

Referring to FIG. 1, a locating block holding device 10, according to a first preferred embodiment, includes a fixture floor 12, at least one locating block 14 and a magnet 16.

The fixture floor 12 serves as a support means for holding the locating block 14, the magnet 16 and a workpiece. The fixture floor 12 includes an upper surface 122 and a lower surface 124 opposite to the upper surface 122. The fixture floor 12 defines a channel 126 in the upper surface 122 and a coaxial receiving groove 128 formed in the lower surface 124 thereof. The channel 126 has a shoulder 127 formed between the receiving groove 128 and the channel 126. A spacer 123 formed between the channel and 126 the receiving groove 128 to space the channel 127 and the receiving groove 128 and provide the shoulder 127 to support the locating block 14. The channel 126 is communicated with the receiving groove 128 via a coaxially defined hole 125 on the spacer 123 of the fixture floor 12.

The locating block 14 is disposed on the shoulder 127 in the channel 126 of the fixture floor 12. The locating block 14 is made from magnetic material such that the magnet is capable of firmly and stably holding the locating block 14 on the shoulder in the channel 126, which can be selected from iron, nickel, cobalt, alloys or a combination of two or more materials as above mentioned. The locating block 14 is not limited in shape and may be cube, cylinder, or prism shaped and so on.

The magnet 16 is tightly fitted in the receiving groove 128 of the fixture floor 12. The magnet 16 can be a permanent magnet or an electromagnet.

In the first present embodiment, the magnetic field of the magnet 16 firmly holds the locating block 14 in the channel 126 of the fixture floor 12. The locating block 14, serving as a positioning reference for accurately and conveniently positioning the workpiece, is stably held on the fixture floor 12 by the magnet 16. The locating block 14 can be disassembled from the channel 126 of the fixture floor 12 conveniently, easily, and quickly. Because holding or fixing the locating block 14 in place only depends on the magnetic field of the magnet 16 it is not necessary to form another structure on the locating block 14 to fix the locating block 14 but the location accuracy of the locating block holding device 10 is maintained. In addition, it is very easy and convenient to disassemble or replace the magnet 16 via a proper tool passing through the hole 125 of the spacer 123 to push the magnet 16 out of the receiving groove 128 when the locating block 14 has been disassembled from the channel 126 of the fixture floor 12.

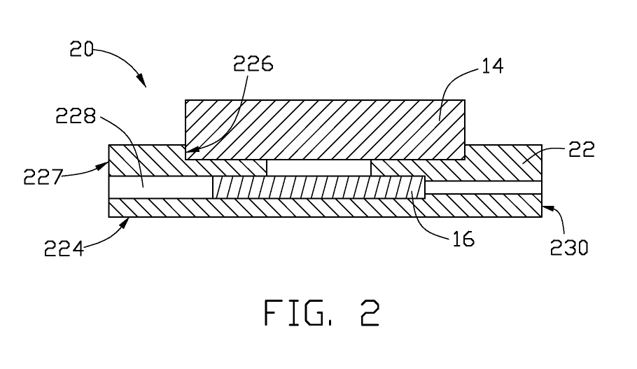

Referring to FIG. 2, a locating block holding device 20, according to a second preferred embodiment, is shown. The locating block holding device 20 is similar to the locating block holding device 10 of the first preferred embodiment, and the difference between them is stated as following.

In this embodiment, the receiving groove 228 is extended from a first side surface 227 to a second side surface 230 opposite to the first side surface 227 underneath the channel 226 of the fixture floor 22, but not exposed on the lower surface 224 of the fixture floor 22. The magnet 16 is tightly fitted in the receiving groove 228 and located underneath the channel 226. When the magnet 16 needs to be replaced or disassembled from the fixture floor 22, it is only needed to push it out of the receiving groove 228 by a proper tool passing through the receiving groove 228. In addition, in this embodiment, the receiving groove 228 being extended from the first side surface 227 to the second side surface 230, can prevent the magnet 16 from accidentally dropping out of the receiving groove 228.

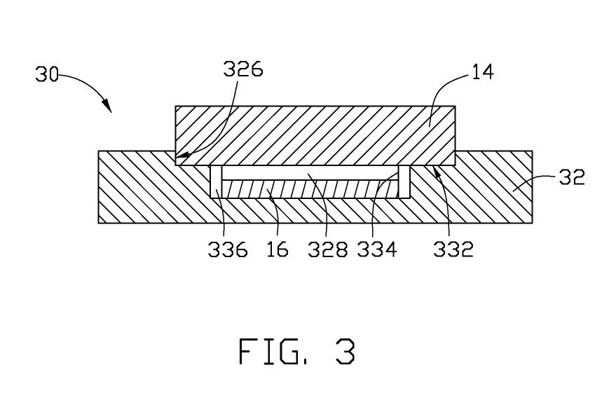

Referring to FIG. 3, a locating block holding device 30, according to a second preferred embodiment. The locating block holding device 30 is similar to the locating block holding device 10 of the first preferred embodiment, and the difference between them is stated as following.

A receiving groove 328 is defined at the bottom 332 of the channel 326 for receiving the magnet 16, and the depth of the receiving groove 328 is deep enough for entirely containing the magnet 16 therein. When the magnet 16 is disposed in the receiving groove 328, the upper surface of the magnet 16 is lower than or on a level with the bottom 332 of the channel 326. The fixture floor 32 has an inner wall 334, which defines the receiving groove 328 therein. At least one slot 336 is defined in the inner wall 334 of the fixture floor 32. The slot 336 communicates with the receiving groove 328, which is used for providing a path or a space for a proper tool to take out the magnet 16 from the receiving groove 328 simply and conveniently. The magnet 16 is tightly fitted in the receiving groove 328. The locating block 14 is disposed in the channel 326 of the fixture floor 32 above the magnet 16, and the locating block 14 is firmly held in the channel 326 by the magnet 16. Thereby, the locating block 14 can be quickly and simply fixed on the fixture floor 32.

It is believed that the present embodiments and their advantages will be understood from the foregoing description, and it will be apparent that various changes may be made thereto without departing from the spirit and scope of the invention or sacrificing all of its material advantages, the examples hereinbefore described merely being preferred or exemplary embodiments of the invention.

What is claimed is:

1. A locating block holding device, comprising:
a fixture floor defining a channel and a receiving groove coaxially formed underneath the channel thereof, the receiving groove communicating with the channel with a shoulder formed between the receiving groove and the channel;
a magnet received in the receiving groove;
a locating block disposed on the shoulder in the channel and above the magnet, the locating block made from magnetic material such that the magnet is capable of firmly and stably holding the locating block on the shoulder in the channel.

2. The locating block holding device as claimed in claim 1, wherein the fixture floor includes an upper surface defining the channel therein, a lower surface opposite to the upper surface, defining the receiving groove therein, a spacer formed between the channel and the receiving groove to space the channel and the receiving groove and provide the shoulder to support the locating block, a through hole being defined in the spacer to allow the channel communicating with the receiving groove.

3. The locating block holding device as claimed in claim 2, wherein the locating block is selected from one of iron, nickel, cobalt, alloys, and a combination of them.

4. The locating block holding device as claimed in claim 2, wherein the locating block has a shape selected from one of cube, cylinder, and prism.

5. The locating block holding device as claimed in claim 2, wherein the magnet is a permanent magnet.

6. The locating block holding device as claimed in claim 2, wherein the magnet is an electromagnet.

7. The locating block holding device as claimed in claim 2, wherein the magnet is tightly fitted into the receiving groove of the fixture floor.

8. The locating block holding device as claimed in claim 1, wherein the fixture floor includes an upper surface, a lower surface opposite to the upper surface, a first side surface and a second opposite side surface between the upper face and lower surface; the channel defined in the upper surface, the receiving groove being defined in the first side surface and extending to the second side surface of the fixture floor underneath the channel and remain within the lower surface; the channel and the receiving groove being separated by a spacer formed in the fixture floor between the channel and the receiving groove, a hole being defined in the spacer for communicating the channel with the receiving groove.

9. The locating block holding device as claimed in claim 1, wherein the fixture floor includes an upper surface defining the channel therein, the receiving groove formed underneath the channel; at least one slot defined in an inner wall of the fixture, wherein the slot is connected with the channel and the receiving groove for providing a space or path to disassemble the magnet from the received groove.

10. The locating block holding device as claimed in claim 1, wherein the upper surface of the magnet is lower than or on a level with the bottom of the channel defined in the fixture floor.
